(19) United States
(12) Patent Application Publication
(10) Pub. No.: US 2009/0143552 A1
(43) Pub. Date: Jun. 4, 2009

(54) METHOD OF POLYMERIZATION OF OLEFIN/ALPHA-OLEFIN USING ARYLOXY-BASED OLEFIN- (CO)POLYMERIZATION CATALYST

(75) Inventors: Eun-Il Kim, Daejeon (KR); Ho-Sik Chang, Daejeon (KR)

Correspondence Address: BARLOW, JOSEPHS & HOLMES, LTD., 101 DYER STREET, 5TH FLOOR, PROVIDENCE, RI, 02903, US

(73) Assignee: SAMSUNG TOTAL PETROCHEMICALS, CO. LTD., Chungcheongnam Province (KR)

(21) Appl. No.: 11/571,089

(22) PCT Filed: Mar. 31, 2005
(86) PCT No.: PCT/KR05/00941

§ 371 Date: Feb. 10, 2009

(30) Foreign Application Priority Data
Jul. 1, 2004 (KR) 10-2004-0051019

(51) Int. Cl. C08F 10/00; C08F 4/50

(52) U.S. Cl. 526/151

(57) ABSTRACT

The present invention provides a method of polymerization of olefin or copolymerization of olefin/alpha-olefin using transition metal compound with an oxidation number of 3 as a catalyst and organo-aluminum compound as a co-catalyst, wherein the transition metal compound with an oxidation number of 3 is produced by reacting organo-magnesium compound with a compound which is formed by reacting transition metal compound having aryloxy group with an oxidation number of 4 or more with external electron donor. According to the present invention, an olefin (co)polymer with a narrow molecular weight distribution is obtained.

### TECHNICAL FIELD

The present invention relates to a method of producing olefin (co)polymer using Ziegler-Natta catalyst produced by reducing transition metal compound with an oxidation number of 4 or more which is coordinated by external electron donor, with organo-magnesium compound, more specifically, to a Ziegler-Natta catalyst in the form of transition metal compound of group IV in the Periodic Table with an oxidation number of 3, reduced by using organo-magnesium compound, from a compound obtained by reacting aryloxy transition metal compound, which is with an oxidation number of 4 or more and has two or more aryloxy ligands combined thereto, with external electron donor containing one or more oxygen, a method preparing the same, and a method of polymerization of olefin and olefin/alpha-olefin using thereof.

### BACKGROUND ART

As for the reaction polymerizing olefin by using transition metal compound as a catalyst, U.S. Pat. No. 4,894,424 discloses a method of producing ethylene polymer and copolymer using transition metal compound of group IV in the Periodic Table as a catalyst. The catalyst is produced by reduction reaction of grignard compound (RMgCl, wherein R is alkyl group) obtained by reacting transition metal compound of group IV, V or VI in the Periodic Table with an oxidation number of at least 4, for example, titanium compound having a general formula of Ti(OR)ₘClₙ (wherein n+m=4), magnesium (Mg) and alkyl chloride (RCl). 80% or more of the titanium metals contained in the catalyst exist in the form of an oxidation number of 3 (Ti³⁺) since the catalyst is produced by reduction reaction with grignard compound.

### DISCLOSURE OF INVENTION

### Technical Problem

As a method of producing olefin (co)polymer with a narrow molecular weight distribution using transition metal compound as a catalyst, U.S. Pat. No. 5,055,535 discloses a method of producing an ethylene (co)polymer by adding ether as an external electron donor and alkyl aluminum as a cocatalyst, during polymerization using a catalyst obtained by treating magnesium dichloride (MgCl₂) with dibutyl phthalate and titanium tetrachloride (TiCl₄).

U.S. Pat. No. 3,989,881 discloses a method of producing ethylene polymer by using a catalyst obtained by coordinating magnesium dichloride (MgCl₂) with tetrahydrofuran (THF) and then treating the coordinated magnesium compound with titanium tetrachloride coordinated with tetrahydrofuran, [(TiCl₄)(THF)ₙ].

U.S. Pat. No. 4,684,703 discloses a method of producing ethylene polymer by using a catalyst containing titanium tetrachloride (TiCl₄) supported by a carrier obtained by treating magnesium dichloride (MgCl₂) with alkyl ester or ether.

U.S. Pat. No. 5,322,830 discloses a method of producing ethylene polymer by using a catalyst obtained by coordinating magnesium dichloride (MgCl₂) with ethanol (EtOH) and then treating the coordinated magnesium compound with triethyl aluminum (TEA) and ethoxy titanium trichloride (EtOTiCl₃).

U.S. Pat. No. 4,980,329 discloses a method of producing propylene polymer by using a catalyst containing titanium tetrachloride (TiCl₄) supported by a carrier obtained by co-milling magnesium dichloride (MgCl₂) with external electron donor selected from ester, ketone, aldehyde, amide, lactone, phosphine and silicone.

U.S. Pat. Nos. 4,668,650 and 4,973,694 disclose methods of producing ethylene (co)polymer by using a catalyst obtained by reacting hydroxyl group of silica-gel in the solvent mixture of alkyl magnesium and tetrahydrofuran and then treating the resulting compound with titanium tetrachloride (TiCl₄).

Furthermore, U.S. Pat. No. 5,939,348 discloses a method of producing propylene polymer by using a catalyst obtained by pre-treating hydroxyl group of silica-gel with alkyl magnesium and tetraethoxysilane (Si(OEt)₄) and then treating the resulting compound with titanium tetrachloride (TiCl₄).

However, the prior arts as above have economical disadvantages in the case of commercial applications owing to their complicated processes, and also have some problems such as a by-product treatment or the like

### Technical Solution

The object of the present invention is to provide a method of producing olefin (co)polymer with a narrower molecular weight distribution compared with the case of using conventional catalyst of transition metal compound of group IV in Periodic Table with an oxidation number of 3, by using Ziegler-Natta catalyst produced by reducing transition metal compound with an oxidation number of 4 or more which is introduced with aryloxy ligand and coordinated by external electron donor, with organo-magnesium compound.

### MODE FOR THE INVENTION

According to the present invention, provided is a method of polymerization of olefin or copolymerization of olefin/alpha-olefin using transition metal compound with an oxidation number of 3 as a catalyst and organo-aluminum compound as a cocatalyst, wherein the transition metal compound with an oxidation number of 3 is produced by reacting organo-magnesium compound with a compound which is formed by reacting transition metal compound having aryloxy group with an oxidation number of 4 or more with external electron donor.

The transition metal compound having aryloxy group with an oxidation number of 3, the catalyst for olefin (co)polymerization in the present invention, is produced by reacting organo-magnesium compound with a compound obtained by reacting aryloxy transition metal compound, which is with an oxidation number of 4 or more and has two or more aryloxy ligands combined thereto, with external electron donor containing one or more oxygen.

As shown in the following reaction formula I, conventional Ziegler-Natta catalyst (C) is produced by reduction reaction of (A), titanium compound with an oxidation number of 4 represented in the formula of Ti(OR₁)ₘClₙ (wherein n+m=4), and (B), organo-magnesium compound obtained by Grignard method. However, as shown in the following reaction formula II for example, the Ziegler-Natta catalyst (H) according to the present invention is produced by using (D), transition metal compound having aryloxy group with an oxidation number of 4 or more, which is substituted for conventional titanium compound (A) of alkoxy group with an oxidation number of 4, in order to narrow the molecular weight distribution of the olefin (co)polymer produced.

[Reaction Formula I]

Ti(OR₁)ₘClₙ+RMgX→(R₁O)ₘ₋₁TiClₙ A B C

(wherein R and R₁ are C₁ to C₆ alkyl groups)

[Reaction Formula II]

MX₄₋ₙ(OAr)ₙ+(ED)_{y}→MX₄₋ₙ(OAr)ₙ(ED)_{y} D E G

MX₄₋ₙ(OAr)ₙ+(ED)_{y}+RMgX→MX₄₋ₙ(OAr)ₙ₋₁(ED)_{y} G B H

(wherein M is transition metal, R is alkyl group of C₁ to C₆, Ar is aryl group or substituted aryl group of C₆ to C₃₀, X is halogen atom, y is an integer of 1 or 2, and n is an integer or a fraction number of 2 to 4)

The transition metal compound with an oxidation number of 4 or more used in the present invention is that of group IV, V or VI transition metal in the Periodic Table, preferably titanium, containing chlorine, aryl radical or aryl chloride. By introducing two or more aryloxy ligand molecules thereto, the transition metal compound having aryloxy group with an oxidation number of 4 or more, (D) for example, is produced.

A method of producing the transition metal compound having aryloxy group with an oxidation number of 4 or more may be performed by suspending aryloxy compound in heptane solvent and adding transition metal compound with an oxidation number of 4 or more dropwisely to the suspension.

The aryloxy compound, for example, 2,6-diisopropyl phenol may be used preferably in the amount of 0.1 to 0.5 mol and the transition metal compound with an oxidation number of 4 or more, for example, titanium tetrachloride may be used preferably in the amount of 0.05 to 0.2 mol.

By coordinating external electron donor (ED) containing one or more oxygen to the transition metal compound having aryloxy group with an oxidation number of 4 or more produced as above, more concretely, by mixing said external electron donor (ED) and said transition metal compound having aryloxy group with an oxidation number of 4 or more and stirring the mixture for 0.5 to 1 hours, the transition metal compound having aryloxy group with an oxidation number of 4 or more, represented in a general formula of MX₄₋ₙ(OAr)ₙ(ED)_{y}(in which M is transition metal, Ar is aryl group or substituted aryl group of C₆ to C₃₀, X is halogen atom, y is an integer of 1 or 2, and n is an integer or a fraction number of 2 to 4), may be produced.

The external electron donor (ED) containing one or more oxygen may be selected from the group consisting of methyl formate, ethyl acetate, butyl acetate, ether, cyclic ether, ethyl ether, tetrahydrofuran, dioxane, acetone, methyl ethyl ketone and the like, and tetrahydrofuran and ether are most preferable. Also, preferably 0.1 to 0.5 mol of the external electron donor may be mixed with 0.1 to 0.5 mol of said transition metal compound having aryloxy group with an oxidation number of 4 or more.

By reacting organo-magnesium compound (B) with the compound represented in a general formula of MX₄₋ₙ(OAr)ₙ(ED)_{y} produced as above, the transition metal compound having aryloxy group with an oxidation number of 3 as a catalyst in the present invention is produced, and at this time, the organo-magnesium compound (B) used may be produced by Grignard method in which alkyl compound such as alkyl chloride is reacted with magnesium, and as a result, halogenated organo-magnesium compound represented in a general formula of MgX₂₋ₘRₘ (in which R is alkyl group of C₁ to C₆, X is halogen atom, and m is a natural number or a fraction number of 0 to 2) is formed.

As a solvent for the reaction of the organo-magnesium compound (B) with the compound represented in a general formula of MX₄₋ₙ(OAr)ₙ(ED)_{y}, aliphatic hydrocarbon such as hexane, heptane, propane, isobutane, octane, decane, kerosene and the like may be used, and among this, hexane and heptane are most preferable. At this time, the organo-magnesium compound may be used in the form of a complex with the solvent or, if required, with electron donor such as ether.

The reaction temperature for the reaction of the organo-magnesium compound (B) with the compound represented in a general formula of MX₄₋ₙ(OAr)ₙ(ED)_{y}, is preferably −20 to 150° C.

The reaction of the organo-magnesium compound (B) with the compound represented in a general formula of MX₄₋ₙ(OAr)ₙ(ED)_{y}, is preferably conducted in the presence of alkyl halide compound, RX (in which R is alkyl group of C₁ to C₆ and X is halogen atom).

In the reaction of the organo-magnesium compound (RMgX or MgR₂) with the compound which is formed by reacting transition metal compound having aryloxy group with an oxidation number of 4 or more with external electron donor and, for example, represented in a general formula of MX₄₋ₙ(OAr)ₙ(ED)_{y}, optionally in the presence of alkyl halide compound (RX), the reaction molar ratios between the compounds may be:

0.1≦MX₄₋ₙ(OAr)ₙ(ED)_{y}/RMgX≦0.5; and

1≦RX/RMgX≦2

or

0.1≦MX₄₋ₙ(OAr)ₙ(ED)_{y}/MgR₂≦0.5; and

2≦RX/MgR₂≦4

When the reaction molar ratios go beyond the ranges as above, there is a problem of considerable reduction in the yield of each reaction.

Furthermore, magnesium metal (Mg) may be used instead of the organo-magnesium compound (RMgX or MgR₂), and at this time, the reaction molar ratios between the compounds may be:

0.1≦MX₄₋ₙ(OAr)ₙ(ED)_{y}/Mg≦0.5

0.5≦RX/Mg≦10, preferably, 1≦RX/Mg≦2

As a cocatalyst used in the present invention, organo-metal compound of group II or III in the Periodic Table may be used, and preferrably, organo-aluminum compound having a general formula of AlRₙX₃₋ₙ (in which R is alkyl group of C₁ to C₁₆, X is halogen atom, and n is an integer or a fraction number of 1 to 3) is used.

The organo-aluminum compound as a cocatalyst may be preferably selected from the group consisting of triethyl aluminum, trimethyl aluminum, trinormalpropyl aluminum, trinormalbutyl aluminum, triisobutyl aluminum, trinormalhexyl aluminum, trinormaloctyl aluminum, tri-2-methylpentyl aluminum, and the like, and among this, triethyl aluminum, trinormalhexyl aluminum and trinormaloctyl aluminum are most preferable.

The molar ratio of the organo-aluminum compound as a cocatalyst to the transition metal in the catalyst, is preferably 0.5 to 500 and, depending on the characteristics of each process for slurry, gas phase or solution polymerization and on the particular properties required for each polymer, adequate range of it may be selected, however, when it goes beyond the range as above, there may be a problem of reduction in activity of the catalyst.

The olefin (co)polymerization reaction in the present invention may be performed by introducing monomer comprising ethylene and optionally other olefin into liquid diluent such as saturated aliphatic hydrocarbon with a catalyst system. In case of absence of liquid diluent, it may be performed by directly contacting a gas-phase monomer with a catalyst system. The olefin (co)polymerization reaction is generally performed in the presence of a chain growth inhibitor such as hydrogen and the volume of olefin monomer is generally within a range of 1 to 80% of the olefin monomer and hydrogen.

The reaction pressure and temperature for olefin (co)polymerization are preferably 15 bar or less and 40 to 150° C., respectively.

In the olefin (co)polymerization reaction, each component may be successively fed during polymerization process without additional reactions or treatments, or may be used in the form of pre-polymer obtained by mixing and reacting in advance.

That is, it may be possible to react by directly feeding the polymerization catalyst along with olefin monomer into a reactor, or by feeding the pre-polymer obtained by pre-polymerizing one or more olefin monomers in inert liquid such as aliphatic hydrocarbon, into a reactor. In this case, the organo-metal compound as a cocatalyst may be directly fed into the reactor.

The olefin (co)polymer produced according to the present invention has very high impact strength due to its narrow molecular weight distribution.

The present invention is described in more detail referring to the following examples. However, the examples are merely referred for the purpose of exemplification, and the present invention is not limited thereto.

### EXAMPLE 1

### Ethylene Polymerization Reaction

i) Preparation of Transition Metal Compound Having Aryloxy Group with an Oxidation Number of 4 or More with External Electron Donor Introduced

42.8 g of 2,6-diisopropyl phenol (0.24 mol) was suspended into 150 ml of purified heptane in a 0.5 L 4-neck flask mounted with a mechanical stirrer. Then, 13.2 ml of titanium tetrachloride (0.12 mol) was added dropwisely at a constant rate to the suspension. After completing the dropwise addition, the reaction was conducted for 12 hours, and then, 19.5 ml of tetrahydrofuran (0.24 mol) as an external electron donor was fed into the reactor and stirring was continued for one hour to obtain a titanium compound represented in the formula of TiCl₂(OAr)₂(THF)₂ into which the external electron donors were introduced. The obtained titanium compound was used directly for producing a catalyst without further purification.

ii) Preparation of Olefin (Co)Polymerization Catalyst

12.7 g, of magnesium (0.525 mol) and 1.4 g of iodine (0.005 mol) were suspended into 450 ml of purified heptane in a 1 L 4-neck flask mounted with a mechanical stirrer. After raising the temperature of the suspension to about 70° C., the resulting titanium compound finally obtained from above stage i) was added and 84.1 ml of 1-chlorobutane (0.8 mol) was added dropwisely at a constant rate to the suspension. After completing the dropwise addition, the reaction was conducted for 2 hours, and then, the reaction product was washed four times with sufficient hexane to obtain the catalyst and the obtained catalyst was kept as a slurry in hexane. According to the results of analysis for the components in the catalyst slurry, total titanium content was 3.65 wt % and the amount of titanium with an oxidation number of 3 is 78 wt % of the total titanium.

iii) Ethylene Polymerization Reaction

Into a 2 L stainless steel reactor equipped with stirrer and heating/cooling device, 1000 ml of purified hexane was charged. The reactor was sufficiently purged with pure nitrogen gas prior to use. Then, as a cocatalyst, 2 cc of trinormaloctyl aluminum (TnOA) diluted in hexane to a concentration of 1M, was fed into the reactor, and 4.5 ml of the catalyst slurry (6 mmol of titanium) produced at the stage ii) above was fed into the reactor. After raising the reactor temperature up to 80° C., 66 psig of hydrogen was fed and sufficient ethylene was fed to make the total pressure in the reactor 187 psig, and then polymerization reaction was started by stirring with 1000 rpm. The polymerization reaction was conducted for one hour, and during the reaction, sufficient ethylene was supplied so as to maintain the total pressure in the reactor to 187 psig constantly. After the reaction was completed, 10 cc of ethanol was injected into the reactor to eliminate the catalyst activity. The obtained polymer was isolated by a filter, and was dried to yield 70.3 g of polyethylene.

### EXAMPLE 2

### Ethylene/1-hexene copolymerization reaction

Into a 2 L stainless steel reactor equipped with stirrer and heating/cooling device, 800 ml of purified hexane and 150 ml of 1-hexene were charged. The reactor was sufficiently purged with pure nitrogen gas prior to use. Then, as cocatalyst, 8 cc of trinormaloctyl aluminum (TnOA) diluted in hexane to a concentration of 1M, was fed into the reactor, and 10 ml of the catalyst slurry (12 mmol of titanium) produced at the stage ii) in Example 1 above was fed into the reactor. After raising the reactor temperature up to 80° C., 1000 cc of hydrogen was fed and sufficient ethylene was fed to make the total pressure in the reactor 120 psig, and then polymerization reaction was started by stirring with 1000 rpm. The polymerization reaction was conducted for 10 minutes, and during the reaction, sufficient ethylene was supplied so as to maintain the total pressure in the reactor to 120 psig constantly. After the reaction was completed, 1500 ml of ethanol was added to the reaction solution to eliminate the catalyst activity. The obtained polymer was isolated by a filter, and was dried to yield 46.8 g of ethylene/1-hexene copolymer.

### COMPARATIVE EXAMPLE 1

### Ethylene Polymerization Reaction

i) Preparation of Olefin (Co)Polymerization Catalyst

12.7 g, of magnesium (0.525 mol) and 1.4 g of iodine (0.005 mol) were suspended into 450 ml of purified heptane in a 1 L 4-neck flask mounted with a mechanical stirrer. After raising the temperature of the suspension to about 70° C., 56.6 g of bis(2,6-diisopropylphenoxy)titanium dichloride (0.12 mol) dissolved in 150 ml of heptane was added and 84.1 ml of 1-chlorobutane (0.8 mol) was added dropwisely at a constant rate to the suspension. After completing the dropwise addition, the reaction was conducted for 2 hours, and then, the reaction product was washed four times with sufficient hexane to obtain the catalyst and the obtained catalyst was kept as a slurry in hexane. According to the results of analysis for the components in the catalyst slurry, total titanium content was 4.4 wt % and the amount of titanium with an oxidation number of 3 is 75 wt % of the total titanium.

ii) Ethylene Polymerization Reaction

Ethylene polymerization reaction was conducted in the same manner as in the stage iii) in Example 1, except that the catalyst obtained from the stage i) above was used instead of the catalyst obtained from the stage ii) in Example 1. 133.5 g of polyethylene was yielded.

### COMPARATIVE EXAMPLE 2

Preparation of olefin (co)polymerization catalyst was carried out in the same manner as in the stage i) in Comparative Example 1, except that 15.2 ml of titanium propoxide (0.056 mol) and 7.2 ml of titanium tetrachloride (0.065 mol) was used instead of bis(2,6-diisopropylphenoxy)titanium dichloride as the transition metal compound with an oxidation number of 4 or more.

Also, ethylene polymerization reaction was conducted in the same manner as in the stage ii) in Comparative Example 1, except that the catalyst obtained as above was used instead of the catalyst obtained from the stage i) in Comparative Example 1. 40.0 g of polyethylene was yielded.

### COMPARATIVE EXAMPLE 3

### Ethylene/1-hexene copolymerization reaction

Ethylene/1-hexene copolymerization reaction was conducted in the same manner as in Example 2, except that the catalyst obtained from the stage i) in Comparative Example 1 was used instead of the catalyst obtained from the stage ii) in Example 1. 47.2 g of ethylene/1-hexene copolymer was yielded.

### COMPARATIVE EXAMPLE 4

Ethylene/1-hexene copolymerization reaction was conducted in the same manner as in Example 2, except that the catalyst obtained from Comparative Example 2 was used instead of the catalyst obtained from the stage ii) in Example 1. 44.5 g of ethylene/1-hexene copolymer was yielded.

The results of (co)polymerization by Examples 1 to 2 and Comparative Examples 1 to 4 are shown in the following Tables 1 and 2.

TABLE 1
Results of ethylene polymerization

Ethylene polymerization reaction

| | MI (g/10 min) | MFRR |
|---|---|---|
| Example 1 | 0.93 | 27.98 |
| Comparative Example 1 | 1.37 | 32.00 |
| Comparative Example 2 | 0.56 | 31.55 |

*MI: Melt Index.
Measured at 190° C. under 2.16 kg load according to ASTM D-1238.
*MFRR: Melt Flow Rate Ratio.
Calculated as MI under 21.6 kg load/MI under 2.16 kg load

TABLE 2
Results of ethylene/1-hexene copolymerization

Ethylene/1-hexene copolymerization

| | MI | MFRR |
|---|---|---|
| Example 2 | 0.31 | 27.93 |
| Comparative Example 3 | 1.09 | 31.80 |
| Comparative Example 4 | 1.32 | 32.24 |

*MI: Melt Index.
Measured at 190° C. under 2.16 kg load according to ASTM D-1238.
*MFRR: Melt Flow Rate Ratio.
Calculated as MI under 21.6 kg load/MI under 2.16 kg load

As shown in Tables 1 and 2, it can be found that the ethylene (co)polymers of Examples 1 and 2 obtained by using Ziegler-Natta catalyst which was prepared by introducing both of the ligand of aryloxy group and the external electron donor into the transition metal compound with an oxidation number of 4 or more and reducing it with the organo-magnesium compound, have smaller MFRR than those of the ethylene (co)polymers of Comparative Examples 2 and 4 where neither ligand of aryloxy group nor external electron donor was introduced into the transition metal compound. Also, it can be found that the ethylene (co)polymers of Examples 1 and 2 have smaller MFRR than those of the ethylene (co)polymers of Comparative Examples 1 and 3 where only the ligand of aryloxy group was introduced into the transition metal compound. MFRR is a value corresponding to the molecular weight distribution, i.e. the larger MFRR, the broader molecular weight distribution, and the molecular weight distribution is an important physical property for the impact strength.

From the description as above, it can be known that the production of olefin (co)polymer with narrow molecular weight distribution is possible by using the catalyst prepared by introducing both of the ligand of aryloxy group and the external electron donor into the transition metal compound with an oxidation number of 4 or more and reducing it with organo-magnesium compound.

### INDUSTRIAL APPLICABILITY

The olefin (co)polymer produced according to the present invention has a narrow molecular weight distribution and a low melt index (MI), and thereby, has an excellent impact strength.

1. A method of polymerization of olefin or copolymerization of olefin/alpha-olefin using transition metal compound with an oxidation number of 3 as a catalyst and organo-aluminum compound as a co-catalyst, wherein the transition metal compound with an oxidation number of 3 is produced by reacting organo-magnesium compound with a compound which is formed by reacting transition metal compound having aryloxy group with an oxidation number of 4 or more with external electron donor.

2. The method according to claim 1, wherein said transition metal compound having aryloxy group with an oxidation number of 4 or more has a general formula of
MX₄₋ₙ(OAr)ₙ
wherein M is transition metal, Ar is un-substituted or substituted aryl group of C₆ to C₃₀, X is halogen atom, y is an integer of 1 or 2, and n is an integer or a fraction number of 2 to 4, and
said organo-magnesium compound has a general formula of MgX₂₋ₘRₘ
wherein R is alkyl group of C₁ to C₆, X is halogen atom, and m is a natural number or a fraction number of 0 to 2.

3. The method according to claim 1, wherein said transition metal compound having aryloxy group with an oxidation number of 4 or more is produced by reacting transition metal compound with an oxidation number of 4 or more with aryloxy compound.

4. The method according to claim 1, wherein said external electron donor is selected from the group consisting of methyl formate, ethyl acetate, butyl acetate, ether, cyclic ether, ethyl ether, tetrahydrofuran, dioxane, acetone and methyl ethyl ketone.

5. The method according to claim 1, wherein the reaction molar ratio of said compound which is formed by reacting transition metal compound having aryloxy group with an oxidation number of 4 or more with external electron donor, to said organo-magnesium compound, is 0.1-0.5.

6. The method according to claim 1, wherein the reaction of said organo-magnesium compound with said compound which is formed by reacting transition metal compound having aryloxy group with an oxidation number of 4 or more with external electron donor, is carried out in the presence of alkyl halide compound.

7. The method according to claim 1, wherein said organo-aluminum compound has a general formula of
AlRₙX₃₋ₙ
wherein R is alkyl group of C₁ to C₁₆, X is halogen atom, and n is an integer or a fraction number of 1 to 3.

8. The method according to claim 7, wherein said organo-aluminum compound is selected from the group consisting of triethyl aluminum, trimethyl aluminum, tri-normalpropyl aluminum, trinormalbutyl aluminum, triisobutyl aluminum, tri-normalhexyl aluminum, trinormaloctyl aluminum and tri-2-methylpentyl aluminum.

9. The method according to claim 1, wherein the molar ratio of said organo-aluminum compound to the transition metal in said catalyst, is 0.5 to 500.
